(19) United States
(12) Patent Application Publication
(10) Pub. No.: US 2023/0322125 A1
(43) Pub. Date: Oct. 12, 2023

(54) BATTERY CONTROL SYSTEM FOR VEHICLE

(71) Applicant: ISUZU MOTORS LIMITED, Kanagawa (JP)

(72) Inventor: Kota KATO, Fujisawa-shi (JP)

(21) Appl. No.: 18/187,095

(22) Filed: Mar. 21, 2023

(30) Foreign Application Priority Data
Mar. 23, 2022 (JP) 2022-047459

(51) Int. Cl. B60L 58/24; B60L 58/18

(52) U.S. Cl. CPC B60L 58/24; B60L 58/18; B60L 2240/54

(57) ABSTRACT

A temperature judgment section judges whether or not the temperature of a battery pack is equal to or higher than a predetermined lowest threshold temperature. A battery connection/disconnection control section configured to control the battery connection/disconnection section such that a first predetermined number of battery packs are connected to the load when temperatures of all of the plurality of battery packs are equal to or higher than the lowest threshold temperature at a start of power supply from the battery module to the load, and control the battery connection/disconnection section such that a second predetermined number of battery packs are connected to the load when temperatures of all of the plurality of battery packs are lower than the lowest threshold temperature at the start of power supply from the battery module to the load, the second predetermined number being less than the first predetermined number.

### CROSS REFERENCE TO RELATED APPLICATIONS

This application is entitled to the benefit of Japanese Patent Application No. 2022-047459, filed on Mar. 23, 2022, the disclosure of which including the specification, drawings and abstract is incorporated herein by reference in its entirety.

### TECHNICAL FIELD

The present disclosure relates to a battery control system for a vehicle.

### BACKGROUND ART

Patent Literature 1 (hereinafter, referred to as “PTL” 1) discloses an electric vehicle including a first battery pack and a second battery pack that constitute a battery module, and a driving motor. The first battery pack and the second battery pack are connected in parallel, and a first contactor and a second contactor are interposed between, on one hand, the first battery pack and the second battery pack and, on the other hand, the driving motor.

### CITATION LIST

### Patent Literature

PTL 1 Japanese Patent Application Laid-Open No. 2020-167864

### SUMMARY OF INVENTION

### Technical Problem

There is an operating temperature range suitable for battery packs to be used. Use of the battery packs at a temperature lower than the operating temperature range causes a decrease in battery capacity or a shorter life. For this reason, it is not preferable to use the battery packs for a long time at a temperature lower than the operating temperature range. However, when the vehicle is parked at a low temperature for a long time and the temperatures of the battery packs drop lower than the operating temperature range, it may take time for the battery packs to reach the operating temperature range after the start of the vehicle.

Therefore, the present disclosure aims to provide a battery control system in which in a vehicle including a plurality of battery packs connected in parallel to a load, a low-temperature battery pack supplying electric power is efficiently raised after the start of the electric power supply to the load.

### Solution to Problem

In order to achieve the above purpose, a first aspect of the present disclosure is a battery control system for a vehicle in which a battery module including a plurality of battery packs is mounted and the plurality of battery packs are connected in parallel to a load, the battery control system including a battery connection/disconnection section, a temperature judgment section, and a battery connection/disconnection control section.

The battery connection/disconnection section is interposed between the battery module and the load and is capable of connecting and disconnecting each of the plurality of battery packs individually to and from the load. The temperature judgment section judges whether or not a temperature of each of the plurality of battery packs is equal to or higher than a predetermined lowest threshold temperature. The battery connection/disconnection control section controls the battery connection/disconnection section such that a first predetermined number of battery packs are connected to the load when the temperature judgment section judges that temperatures of all of the plurality of battery packs are equal to or higher than the lowest threshold temperature at a start of power supply from the battery module to the load, and controls the battery connection/disconnection section such that a second predetermined number of battery packs are connected to the load when the temperature judgment section judges that the temperatures of all of the plurality of battery packs are lower than the lowest threshold temperature at the start of power supply from the battery module to the load, the second predetermined number being less than the first predetermined number.

A second aspect of the present disclosure is the battery control system of the first aspect, in which the second predetermined number is equal to or greater than a minimum number of battery packs required for travel of the vehicle.

A third aspect of the present disclosure is the battery control system according to the first or second aspect, in which when a part of the plurality of battery packs is to be connected to the load, the battery connection/disconnection control section preferentially connects a battery pack having a high temperature.

### Advantageous Effects of Invention

According to the battery control system of the present disclosure, in a vehicle including a plurality of battery packs connected in parallel to a load, the temperature of a low-temperature battery pack supplying electric power is efficiently raised after the start of the electric power supply to the load.

### BRIEF DESCRIPTION OF DRAWINGS

FIG. 1 is a side view schematically illustrating a vehicle in which a battery module according to one embodiment of the present disclosure is mounted;

FIG. 2 is a block diagram illustrating a battery control system of the embodiment of FIG. 1;

FIG. 3 is a flowchart illustrating a current control process; and

FIG. 4 is a flowchart illustrating a connection/disconnection control process of a battery pack.

### DESCRIPTION OF EMBODIMENTS

Hereinafter, one embodiment of the present disclosure will be described with reference to the drawings. A battery control system of the present embodiment is disposed in a vehicle such as an electric vehicle or a hybrid vehicle.

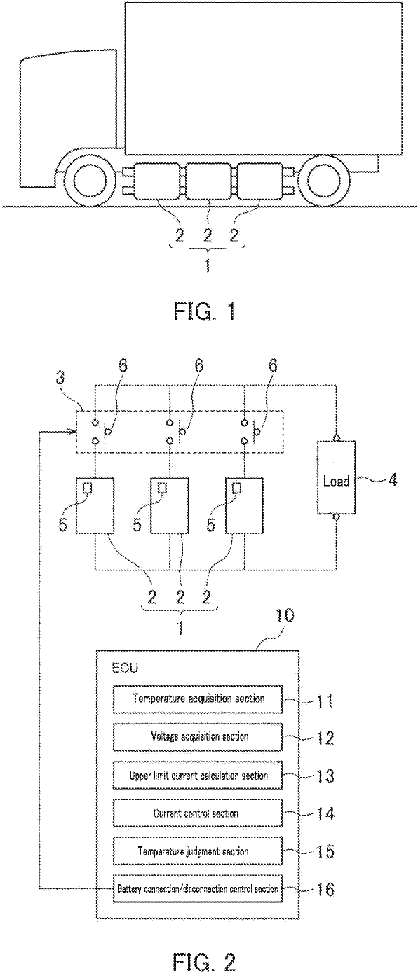

As illustrated in FIG. 1, a plurality of (three in the present embodiment) battery packs 2 are mounted in a vehicle. The plurality of battery packs 2 constitute battery module 1. Although FIG. 1 illustrates an example in which battery module 1 is mounted in a truck, the vehicle is not limited to the truck.

As illustrated in FIG. 2, the battery control system includes battery module 1, battery connection/disconnection section 3, load 4, and battery control apparatus 10.

The plurality of battery packs 2 are connected in parallel to load 4. Each of battery packs 2 is provided with temperature sensor 5 for detecting the temperature of battery pack 2. Load 4 includes a driving motor (not illustrated) that propels the vehicle. The driving motor is driven by electric power supplied by battery module 1.

Battery connection/disconnection section 3 is composed of the same number of contactors 6 as battery packs 2, and is interposed between battery module 1 and load 4. The ON/OFF states of contactors 6 connect or disconnect the plurality of battery packs 2 individually to and from load 4. In the present embodiment, a state in which all battery packs 2 are connected to load 4 (a state in which all contactors 6 are in the ON state) will be described as a standard connection pattern (a normal state) of battery connection/disconnection section 3.

Battery control apparatus 10 is, for example, an Electronic Control Unit (ECU), and includes a Central Processing Unit (CPU), Read Only Memory (ROM), Random Access Memory (RAM), an input/output circuit, and the like. Battery control apparatus 10 functions as temperature acquisition section 11, voltage acquisition section 12, upper limit current calculation section 13, current control section 14, temperature judgment section 15, and battery connection/disconnection control section 16 by performing control programs stored in advance.

Temperature acquisition section 11 sequentially acquires the temperatures of battery packs 2 from temperature sensors 5. Voltage acquisition section 12 sequentially acquires, from a voltage sensor (not illustrated), voltages (voltage values of battery packs 2) between terminals of battery packs 2.

Battery control apparatus 10 stores upper limit current value information (for example, a map or the like) indicating a correspondence between the temperatures, the voltage values, and the upper limit current values of battery packs 2. The term “upper limit current value” means an upper limit current value effective for protection of battery pack 2 and the like, and when the voltage value is constant, the upper limit current value decreases as the temperature increases. There is an operating temperature range suitable for battery packs 2 to be used, and when the temperature becomes higher than the operating temperature range, the upper limit current value is significantly reduced. The upper limit current value information is obtained in advance by simulation or the like and stored in battery control apparatus 10.

Upper limit current calculation section 13 calculates the individual upper limit current values of battery packs 2 using the temperatures of battery packs 2 acquired by temperature acquisition section 11, the voltage values of battery packs 2 acquired by voltage acquisition section 12, and the upper limit current value information.

Current control section 14 controls the current values of battery packs 2 such that the current values are equal to or lower than the upper limit current values. Since battery packs 2 are connected in parallel, a total current value of current flowing through battery module 1 is evenly distributed to battery packs 2, and the current values of respective battery packs 2 are equal to one another. Current control section 14 controls the total current value such that a current equal to or lower than the lowest upper limit current value among the upper limit current values of battery packs 2 connected in parallel flows through battery packs 2.

Battery control apparatus 10 stores a lowest threshold temperature of each of battery packs 2. The lowest threshold temperature is a temperature of battery pack 2 that is lower than the lower limit of the operating temperature range of battery pack 2, and for which it is highly likely to take a long time to reach the lower limit of the operating temperature range by a temperature rise of battery pack 2 by its own internal resistance after the power supply from battery pack 2 is started. The lowest threshold temperature is obtained in advance by simulation or the like, and is stored in battery control apparatus 10.

Temperature judgment section 15 compares the temperatures of all battery packs 2 acquired by temperature acquisition section 11 with the lowest threshold temperature, and judges whether or not each of the temperatures is equal to or higher than the lowest threshold temperature. Such judgment may be performed only at the start of power supply from battery module 1 to load 4, or may be performed at all times (for example, each time temperature acquisition section 11 acquires the temperature).

When temperature judgment section 15 judges that the temperatures of all (three) of the plurality of battery packs 2 are equal to or higher than the lowest threshold temperature at the start of power supply from battery module 1 to load 4, or when temperature judgment section 15 judges that the temperature of a part (one or two) of the plurality of battery packs 2 is lower than the lowest threshold temperature, battery connection/disconnection control section 16 controls battery connection/disconnection section 3 such that a first predetermined number of battery packs 2 are connected to load 4. That is, when one or more battery packs 2 having a temperature equal to or higher than the lowest threshold temperature are present, the first predetermined number of battery packs 2 are connected.

On the other hand, when temperature judgment section 15 judges that the temperatures of all of the plurality of battery packs 2 are lower than the lowest threshold temperature, battery connection/disconnection control section 16 controls battery connection/disconnection section 3 such that a second predetermined number of battery packs 2, where the second predetermined number is smaller than the first predetermined number (the first predetermined number > the second predetermined number), are connected to load 4. When the second predetermined number of battery packs 2 are connected, battery connection/disconnection control section 16 preferentially connects high-temperature battery pack 2.

The second predetermined number is set to be equal to or greater than the minimum number of battery packs 2 required for the vehicle to travel. The second predetermined number may be a fixed value, or may be a variable value that is calculated and set each time depending on a state of the vehicle (for example, a loading amount). In the present embodiment, “3” that is the number of connections in a normal connection pattern is set as the first predetermined number. In addition, the minimum number of battery packs 2 required for the vehicle to travel is 2, and “2” is set as the second predetermined number (fixed value).

When temperature judgment section 15 judges that the temperature of a part (one or two) of the plurality of battery packs 2 is less than the lowest threshold temperature, battery connection/disconnection section 3 may be controlled to connect the second predetermined number of battery packs 2 to load 4.

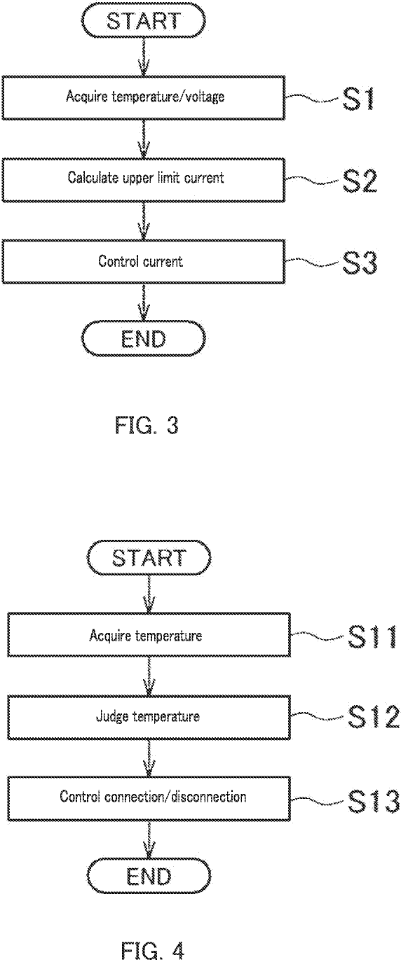

Next, the current control process executed by battery control apparatus 10 and the connection/disconnection control process for connection/disconnection of battery pack 2 will be described with reference to the flowcharts of FIGS. 3 and 4. Battery control apparatus 10 repeatedly executes the current control process while electric power is supplied by battery module 1 to load 4. Further, battery control apparatus 10 executes the connection/disconnection control process for connection/disconnection of battery pack 2 when the power supply from battery module 1 to load 4 is started (for example, when the power of the vehicle is turned on). In order to acquire the voltage values of all battery packs 2, battery control apparatus 10 connects all battery packs 2 to load 4 before the connection/disconnection control process (setting connection/disconnection section 3 to the standard connection pattern).

In the current control process, as illustrated in FIG. 3, the temperatures and voltage values of three battery packs 2 are acquired, (step S1), and the upper limit current value of each of battery packs 2 is calculated individually using the acquired temperature and voltage value of battery pack 2 and the upper limit current value information (step S2).

After the upper limit current values of three battery packs 2 are calculated, the total current value of battery module 1 is controlled such that a current equal to or less than the lowest upper limit current value among the upper limit current values flows through battery packs 2.

In the connection/disconnection control process, as illustrated in FIG. 4, the temperatures of three battery packs 2 are acquired (step S11), and it is judged whether or not the acquired temperature of each of battery packs 2 is equal to or higher than the lowest threshold temperature (step S12).

When it is judged that the temperature of at least one of three battery packs 2 is equal to or higher than the lowest threshold temperature, battery connection/disconnection section 3 is controlled so as to connect three battery packs 2 to load 4. On the other hand, when temperature judgment section 15 judges that the temperatures of all of three battery packs 2 are lower than the lowest threshold temperature, battery connection/disconnection section 3 is controlled so as to connect two battery packs 2 having a high temperature to load 4.

In the present embodiment, when the temperatures of all battery packs 2 are lower than the lowest threshold temperature at the time of starting the power supply from battery module 1 to load 4, the second predetermined number (two) of battery packs 2 fewer than the first predetermined number (three) of battery packs connected in the normal state are connected to load 4. That is, the number of connections of battery packs 2 is reduced from three to two. Comparison between the case where the number of connections of battery packs 2 is three and the case where the number of connections of battery packs 2 is two reveals that the current flowing through battery packs 2 is higher and the heating rate of each battery pack 2 heated due to its own internal resistance is higher in the case of two connections than in the case of three connections. Thus, for example, in a case where the vehicle is parked for a long time at a low temperature and the temperatures of all battery packs 2 are lowered below the lowest threshold temperature, it is possible to efficiently heat low-temperature battery packs 2 supplying electric power after the start of the electric power supply to load 4, and to shorten the time for the temperatures of battery packs 2 to reach the operating temperature range.

Since the second predetermined number is equal to or greater than the minimum number of battery packs 2 required for the vehicle to travel, it is possible to ensure the minimum travel of the vehicle even when the number of connections of battery packs 2 is reduced.

In addition, when a part of battery packs 2 is connected to the load, high-temperature battery pack 2 is preferentially connected, and it is thus possible to shorten the time required to reach the operating temperature range, in comparison to the case where low-temperature battery pack 2 is connected.

Although the present invention has been described based on the above-described embodiments, the present invention is not limited to the contents of the above-described embodiments and can be modified as appropriate without departing from the scope of the present invention. That is, it is needless to say that all other embodiments, examples, operation techniques, and the like made by a person skilled in the art or the like based on this embodiment are included in the scope of the present invention.

For example, the above embodiment has been described in relation to an example in which three battery packs 2 constitute battery module 1, and three (all) battery packs 2 are connected in parallel to load 4 in the normal state. However, the number of battery packs 2 constituting battery module 1 is not limited to the above, and the battery module only need to include a plurality of battery packs. In addition, some of battery packs 2 may be connected to load 4 in the normal state.

### INDUSTRIAL APPLICABILITY

The present disclosure is applicable to a vehicle including a plurality of battery packs connected in parallel to a load.

What is claimed is:

1. A battery control system for a vehicle in which a battery module including a plurality of battery packs is mounted and the plurality of battery packs are connected in parallel to a load, the battery control system comprising:
a battery connection/disconnection section interposed between the battery module and the load and capable of connecting and disconnecting each of the plurality of battery packs individually to and from the load;
a temperature judgment section configured to judge whether or not a temperature of each of the plurality of battery packs is equal to or higher than a predetermined lowest threshold temperature; and
a battery connection/disconnection control section configured to control the battery connection/disconnection section such that a first predetermined number of battery packs are connected to the load when the temperature judgment section judges that temperatures of all of the plurality of battery packs are equal to or higher than the lowest threshold temperature at a start of power supply from the battery module to the load, and control the battery connection/disconnection section such that a second predetermined number of battery packs are connected to the load when the temperature judgment section judges that the temperatures of all of the plurality of battery packs are lower than the lowest threshold temperature at the start of power supply from the battery module to the load, the second predetermined number being less than the first predetermined number.

2. The battery control system for the vehicle according to claim 1, wherein
the second predetermined number is equal to or greater than a minimum number of battery packs required for travel of the vehicle.

3. The battery control system for the vehicle according to claim 1, wherein
when a part of the plurality of battery packs is to be connected to the load, the battery connection/disconnection control section preferentially connects a battery pack among the plurality of battery packs having a high temperature.
